(19) United States
(12) Patent Application Publication
(10) Pub. No.: US 2012/0240749 A1
(43) Pub. Date: Sep. 27, 2012

(54) Instrument Tuner for Drums

(76) Inventor: John Eric Bjornson, Shawnigan Lake (CA)

(21) Appl. No.: 13/184,009

(22) Filed: Jul. 15, 2011

Related U.S. Application Data
(60) Provisional application No. 61/467,531, filed on Mar. 25, 2011.

(51) Int. Cl. G10G 7/02

(52) U.S. Cl. 84/454

(57) ABSTRACT

An instrument tuner for drums that has a sensing means for sensing the combined fundamental resonance and pitch from inside the drum; a measurement means for measuring a frequency of said combined fundamental resonance and pitch; and a selection means to then compare the frequency measured to a corresponding musical note of the instrument tuner. Eventhough the sensing means will be internal to the drum, the tuner or display could be external to the drum and/or separate from the sensing means; a wireless device or system is specified also that could be used with this method. A single-note tuner is specified, as well as a tuner designed to recognize more than a single-note, if a wireless device or system is used, as one example, for a complete drumset.

### CROSS REFERENCE TO RELATED PROVISIONAL APPLICATION

This regular application claims benefits of provisional application No. 61/467,531 filed Mar. 25, 2011, the contents of which are incorporated herein by reference.

### DESCRIPTION

### BACKGROUND OF THE INVENTION

1. Field of the Invention

The present invention, an instrument tuner for drums that measures the combined fundamental resonance and pitch from inside the drum, relates to the measurement of the frequency (also called drum pitch) of a musical note of a drum, and optimum display of that information for use by the drummer/or musician in tuning the drum(s).

2. Description of the Prior Art

An instrument tuner for drums is intended to assist a drummer/or musician in tuning a drum(s) or entire drum set. A drum tuner indicates in some way the deviation in frequency of a pre-determined musical note from the frequency/or pitch of the drum; each drum shell may have a different fundamental note or pitch, for e.g. A few devices have been invented and one or two patented (e.g. drum torques and drum dials). However, currently there are no instrument tuners for drums that are designed to measure the combined fundamental resonance and pitch from inside the drum. The prior art found has been very expensive, complex external musical tuners measuring only the acoustic properties of a single drum head, and not the combined fundamental resonance and pitch of the drum from inside the drum. In addition, there is no prior art for pre-determined single-note only drum tuners, that are mounted internally to the drum, or microphone mounted internally to the drum and tuner and measurement means external to the drum, as only one example. A primary difference between Bjornson, et al and prior art is that Bjornson measures the combined fundamental resonance and pitch of the drum from inside the drum, and prior art measures only the acoustic properties of a single drum head, taking measures only externally/or outside the drum. Again, Bjornson is measuring the combined fundamental pitch of the drum (from inside the drum), and not measuring specific properties of a single drum head with a tuner that is external/or outside the drum, very expensive and complex. Bjornson is filling the need of a very low cost, simple drum tuner, that is very fast, accurate . . . with very little/or no interaction required by the user/or drummer. Bjornson also discloses a wireless device, method, and system that could be an integral part of Bjornson's invention, where microphones are mounted internally to the drum or entire drum set, sending wireless or wired signals to a tuner that is located externally/or outside the drum(s) with a measurement, selection, and display means. Again, the primary difference of Bjornson is that the sensing means is always internal to the drum(s) measuring the combined fundamental resonance and/or pitch of the drum(s). No other prior art does this.

Each drum shell may have a different fundamental note/or pitch, and there would be a pre-determined single-note drum tuner mounted inside each drum shell with LED light display for flat, sharp, and in-tune (as only one example). All other tuners on the market are currently designed for multiple notes (i.e. chromatic; all notes of the scale), and are all external guitar tuners . . . and not specifically designed for drums (not specifically designed for drum pitch, drum overtones and decays, resonance, etc.). Drum dials and drum torques have been patented that only measure the tension of a single drum head (either directly from the top of the drum head or from the tightness of the drum lugs/or screws that tighten the head), and not the combined fundamental resonance/or pitch of the drum from inside the drum (of Bjornson). Another patent has attempted to merely combine the drum dial (head tension directly from the top of the head) and drum torque (head tension from tightening of the drum lugs/or screws) concepts [please refer to U.S. Pat. No. 6,925,880 of Roberts filed Nov. 17, 2003; that measures only the acoustic properties of a single drum head from outside/or external to the drum]. U.S. Pat. No. 6,794,569 is merely a triggering device that sends signals to a control box in order to create different sounds for the drum (generates different types of drum sounds) . . . but is not designed for tuning purposes or to detect drum resonance or drum pitch from inside the drum. There are several patents designed for drum triggering. U.S. Pat. No. 5,977,473 is another example of triggering electronic sounds through a control box using internal or external “triggers” to send the signal. These patents do not apply to the drum “tuning” of Bjornson that is designed to measure combined fundamental drum resonance and pitch from inside the drum, and is designed only for “tuning” purposes, and not “triggering” purposes. U.S. Pat. No. 5,533,405 refers to the Drum Dial that measures the tension of a drum head, and not pitch of the drum that Bjornson discloses. Drum torques are similar to the Drum Dial patents that only measure the tension of a drum head, and does not measure the combined fundamental drum pitch from inside the drum. U.S. Pat. No. 6,121,528 refers to drum microphones that could be mounted inside a drum . . . for microphone only purposes (to mic a drum through a PA or speaker system) and does not reference drum “tuning” or drum pitch. In addition, there are a number of guitar tuners on the market that are all chromatic (i.e. measures all musical notes) tuners, and are all external tuners. (U.S. Pat. No. 4,899,636 is one example of the many external chromatic guitar tuners on the market), and not designed to measure the combined fundamental resonance and pitch from inside the drum, and specifically designed for drums. Drums have many overtones, resonances, decay, etc . . . and all external chromatic tuners on the market today are not designed specifically for drums and are mostly for use with guitar tuning. Drums have a very low, specialized pitch with many overtones making it very difficult, expensive, and inaccurate to use any current external tuners on the market.

### SUMMARY OF THE INVENTION

This innovation is an instrument tuner for drums that measures the combined fundamental resonance and pitch from inside the drum. No other tuner on the market does this.

This invention is for a pre-determined “single-note” internally mounted drum tuner (as only one example of this invention), allowing the drummer/or user to tune a drum(s) much faster and more accurately than any prior art tuners with in-tune indicators (that are all chromatic external tuners that accommodate all notes, and not a single note for each drum shell). This innovation results in a smaller display format, enabling a lower cost, lower power, lower weight, and smaller design for manufacture.

During drum tuning, and after using the tapping technique by each drum lug, using drum torques. or drum dials to get the top & bottom drum heads the same tension for max resonance, drummers then have to use an external tuner, piano, or flute, singing the note to get the closest match possible to the drum shell note. Max resonance with the drum heads, while matching the drum shell note; a task that everyone would like to see simplified, from beginning drummers to the pros.

The new drum tuner simplifies a very time consuming and somewhat complex process, for each drum. And like guitars, it would be nice to easily check that the drums are always in tune. And if not, to have the ability to easily adjust each drum, like a string on a guitar. Very simple, low cost, and no holes in the drums. A “single-note”drum tuner.

According to the invention there is provided a “single-note” musical instrument tuner for drums which has a transducer for converting sound vibrations of the drum to electrical signals and a body, either hollow or solid, with a front and back surface and a side surface extending between the front and back surface. The “single-note” drum tuner has a tuner circuit mountable in an interior of said body, with an input of the tuner circuit having an input couplable to an output of said transducer. An output of the tuner circuit is connected to a LED light display/or digital display positioned or positionable so that it is visible to a drummer/or player when the drum is in a playing position. A first portion of the LED light display/or digital display is operative to automatically represent a reference note closest in frequency to a measured tone for a “single-note” capable of being played on said drum; each drum shell is marked with a single note, and each drum tuner will be for a “single note” only. A second portion of the LED light display/or digital display is operative to represent an intuitive indication of whether the measured tone has the same frequency as the reference note (i.e. the single note marked on the drum shell, that is then matched to the single-note internal drum tuner), whether the frequency of the measured tone is one of above and below the reference note, and a relative frequency difference between said measured tone and the reference note.

Preferably. the LED light display is a multi-light display and the intuitive indication includes a red LED light that flashes when the measured tone is one of lower in frequency than the reference note. The multi-light LED display and the intuitive indication also includes a yellow LED light that flashes when the measured tone is one of higher in frequency than the reference note. The multi-light LED display and the intuitive indication also includes a green LED light that flashes when the measured tone is equal in frequency to the reference note. The red and yellow LED lights could be multi-colored, as one example, where both red and yellow LED lights would turn green at the same time when the measured tone is equal in frequency to the reference note. Another example could be where there are three (3) different colored LED lights instead of two (2) to display high, low, and equal in frequency to the reference note.

The display could be digital, LED light, or multi-light and may be mounted within, and substantially flush to, the side surface of the drum on a side closest to a drummer/or player, the LED multi-light display facing the drummer/or player through the top (visible when looking through the top drum head) when the drum/or instrument is in a playing position. LED colored lights can easily be seen through the top drum head, whether or not the drum head is clear, coated, white or black in color. The single-note drum tuner would be internally mounted to the side of the drum, and very close to the top head of the drum so to easily see the LED lights. The drummer/or player would have the option to mount the single-note drum tuner in many different positions inside the drum. The drum tuner could also have LED lights showing through the top and bottom of the tuner, as another example, so it would be easily visable either through top or bottom drum heads. Also, the display could be outside the drum, and microphone (or sensing means) inside the drum, always taking the frequency or drum pitch from inside the drum as a combined fundamental resonance or pitch.

The “single-note” drum tuner circuit may include a filter and AC decoupler operative to filter signals from the transducer to produce a filtered signal. An inverter and follower circuit may be operative to invert the filtered signal. A one shot circuit may be coupled to an output of the inverter and follower circuit and be triggerable in response to a second half of said filtered signal and be operative to produce a square wave output in response to being triggered. A processor may be coupled to the square wave output signal. The processor may be operative to detect a fundamental frequency of the square wave signal and compare it to reference frequency values corresponding to notes of a musical scale, determine a reference note having a frequency closest to the fundamental frequency of the square wave signal, determine a relative difference between the fundamental frequency of the square wave signal and the reference note and output signals to operate the LED light, multi-light, or digital display, including a: A first portion of the LED light display/or digital display is operative to automatically represent a reference note closest in frequency to a measured tone for a “single-note” capable of being played on said drum; each drum shell is marked with a single note, and each drum tuner will be for a “single note” only. A second portion of the LED light display/or digital display is operative to represent an intuitive indication of whether the measured tone has the same frequency as the reference note (i.e. the single note marked on the drum shell, that is then matched to the single-note internal drum tuner), whether the frequency of the measured tone is one of above and below the reference note, and a relative frequency difference between said measured tone and the reference note.

The fundamental frequency of the square wave signal is determined by measuring the period of each of the square wave signal and then averaging the periods so determined to provide an average period. This average period is then used in examining a look up table in the processor non-volatile memory to select a frequency value therein corresponding to a frequency of a closest note to the note being played for display on the LED light display, multi-light display, or digital display as several examples. Because this invention is for a “single-note” drum tuner, the tuner will have a specific note pre-stored or pre-set in memory, and incoming signals will be measured and compared against this pre-set note. For example, if the drum shell is stamped, marked or determined to be a C# as the fundamental note of the drum shell, then a “single-note” drum tuner of a C# will be selected and installed in the drum. The pitch of the drum will then be measured against this pre-set note of the drum tuner, and LED lights will display flat, sharp, or equal (for this single pre-set note only). Each drum in a drum set may have different fundamental notes associated with each drum shell, and there will be “single-note” tuners that are pre-set for each drum. A floor torn drum may be a G note, with a single-note drum tuner of G installed in that specific drum.

A yellow LED light flashes when the tone has a frequency above that of the note, a red LED light flashes when the tone has a frequency below that of the note and a green LED light flashes when the tone has the same frequency as the note. Again, multi-colored LED lights could be used to reduce the number of LED lights needed. Both the red and yellow LED lights could flash green at the same time when the tone of the drum has the same frequency as the pre-set note of the drum tuner.

An instrument tuner for drums that has a sensing means for sensing the combined fundamental resonance and pitch from inside the drum. The instrument tuner has a measurement means for measuring a frequency of said combined fundamental resonance and pitch. The measurement and selection means could be either internal or external to the drum. For example, the microphone could be inside the drum, and the tuner could be outside the drum or located anywhere outside the drum; a wireless device or system could be used as an integral part of this invention where the sensing means is inside the drum (e.g. microphone) sending a wireless signal to the tuner that is located somewhere outside/or external to the drum. A wireless or wired system is part of this specification. Another example is where each drum of a drum set has a microphone installed internally to the drum (as one example), and each microphone would send a signal (wired or wireless) to a single instrument tuner that could be outside/or external to the drum. This invention could be applied to an entire set of drums, or each drum individually. As another example of this invention, the microphone and tuner would all be together in the tuner body with measuring, selection, and display means all together in one unit and installed internally to the drum, where the display (or L.E.D. lights as only one example) would be visible through the drum head (clear or white coated drum head, for e.g.) indicating whether or not the drum is in-tune (green LED light), sharp (yellow LED light), or flat (red LED light). The tuner could be designed for a single pre-determined note, and the LED lights would only illuminate if the drum is in pitch with the single pre-determined note coded into the drum tuner. A low battery light indicator could also be included in order to differentiate with the battery is low, or whether or not the drum is not in pitch/or in-tune with the single pre-determined note coded into the drum tuner.

The instrument tuner for drums will have a measurement means that could be through the use of a wireless device, method, or system that is external/or outside the drum and a microphone mounted internally, as only one example. The instrument tuner for drums will sense the combined fundamental resonance and pitch from inside the drum, wherein the instrument tuner senses the combined fundamental resonance and pitch of the drum and then measures and compares that to a single pre-determined note of the drum tuner. The instrument tuner for drums that has a measurement and comparison means could also use a wireless device, method, or system that is external/or outside the drum and could be designed for an entire drum set or multiple drums, and not just a single drum. The instrument tuner for drums will sense the combined fundamental resonance and pitch from inside the drum, where the instrument tuner senses the combined fundamental resonance and pitch of the drum and then measures, compares, and displays the corresponding musical note through a selection means: this corresponding musical note could be coded into the tuner and pre-determined (i.e. a single note only tuner) or the tuner could detect a range of notes or multiple different notes for different drum pitches. The instrument tuner for drums will have a sensing means for sensing the combined fundamental resonance and pitch from inside the drum, where the sensing means comprises a microphone (as only one example). The sensing means could also detect drum pitch from inside the drum using a vibration sensing means that senses the combined fundamental resonance and pitch of the drum, and does not measure just a single drum head, but the overall combined pitch of the drum. This is a primary difference between Bjornson, et al and prior art where Bjornson measures the combined fundamental resonance and pitch from inside the drum, and prior art measures only the acoustic properties externally of a single drum head.

The instrument tuner for drums, where the sensing means comprises a microphone separate from the tuner that is external to the drum. This could also use a wireless device or system as an integral part of the invention. The instrument tuner for drums has a sensing means for sensing the combined fundamental resonance and pitch from inside the drum, where the sensing means detects frequency of the note through vibration and not microphone (could be another example of the sensing means). The instrument tuner for drums could also have a sensing means that is separate from the tuner that is external to the drum, and could also use a wireless method, device, or system.

A method is also disclosed for a instrument tuner for drums that measures the combined fundamental resonance and pitch from inside the drum, which comprises: (a) a sensing means for sensing a musical note of a drum from inside the drum; and (b) a measurement means for measuring a frequency of said musical drum note; and (c) a selection means for selecting a predetermined lower frequency of the drum note determined through sensing and measuring, a predetermined central frequency of the drum note determined, and a predetermined upper frequency of the drum note determined, said selection means comprising a stored table of frequencies, the lower, central and upper frequencies selected from said stored table as a function of said musical note sensed by said sensing means; and (d) an indicator means for indicating: an off or inactive indication if said frequency of musical drum note sensed and measured is less than said predetermined lower frequency; and an off or inactive indication if said frequency of said musical drum note is greater than said predetermined upper frequency; and a SHARP indication if said frequency of said musical drum note is less than or equal to said predetermined upper frequency and greater than or equal to said predetermined central frequency; and a FLAT indication if said frequency of said musical drum note is greater than or equal to said predetermined lower frequency and less than or equal to said predetermined central frequency.

An instrument tuner for drums that measures the combined fundamental resonance and pitch from inside the drum, where the sensing means comprises a connection to an electrical signal representative of said musical drum note. An instrument tuner for drums that measures the combined fundamental resonance and pitch from inside the drum where the sensing means also comprises a microphone integral to said tuner. An instrument tuner for drums that measures the combined fundamental resonance and pitch from inside the drum where the sensing means internal to the drum comprises a microphone that is separate from a display that is outside the drum. An instrument tuner for drums that measures the combined fundamental resonance and pitch from inside the drum wherein the display only shows or lights-up when the frequency of the drum pitch measured is within the range of the pre-determined single-note of the tuner. The instrument tuner for drums that measures the combined fundamental resonance and pitch from inside the drum where the said indicator and display means comprises an illuminatable element of at least one color. The instrument tuner for drums that measures the combined fundamental resonance and pitch from inside the drum further including a control means for controlling the power state of said tuner. The instrument tuner for drums that measures the combined fundamental resonance and pitch from inside the drum further including a control means for controlling the power state of said tuner, this control means comprising a mechanical switch. The instrument tuner for drums that measures the combined fundamental resonance and pitch from inside the drum where the selection means selects said predetermined central frequency as one of two frequencies: a first frequency if said musical drum note is sharp; and a second frequency if said musical drum note is flat, whereby said selection provides compensation for overshoot in tuning on the part drummer. The instrument tuner for drums that measures the combined fundamental resonance and pitch from inside the drum where the said sensing means is comprised of a connection between said measurement means and an electrical signal representative of said musical drum note external to said musical instrument drum tuner. An instrument tuner for drums that measures the combined fundamental resonance and pitch from inside the drum where an indication of a predetermined duration in the case said frequency of said musical drum note is within a predetermined proximity to a predetermined note whereby said indication informs the user that the drum pitch is near said predetermined drum note to give the user a point of reference while tuning the drum.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a perspective view of a drum with a “single-note” drum tuner internally mounted (as only one example of the invention disclosed).

FIG. 2 is a perspective view, of a drum with a microphone (one e.g. of a sensing means) internally mounted, sending a signal of the measured frequency through a hardwire to a tuner with display that is external to the drum. The vent hole of the drum is used for the hard wire. (only one more example of the invention disclosed).

FIG. 3 is a perspective view of several drums with a microphone (one e.g. of a sensing means) internally mounted in each drum, sending a signal of the measured frequency of each drum using wireless signals or a wireless method to a tuner with display that is external to the drum. This method can be used with a single drum, or an entire drum set, as one more example of the invention disclosed.

### DETAILED DESCRIPTION WITH REFERENCE TO THE DRAWINGS

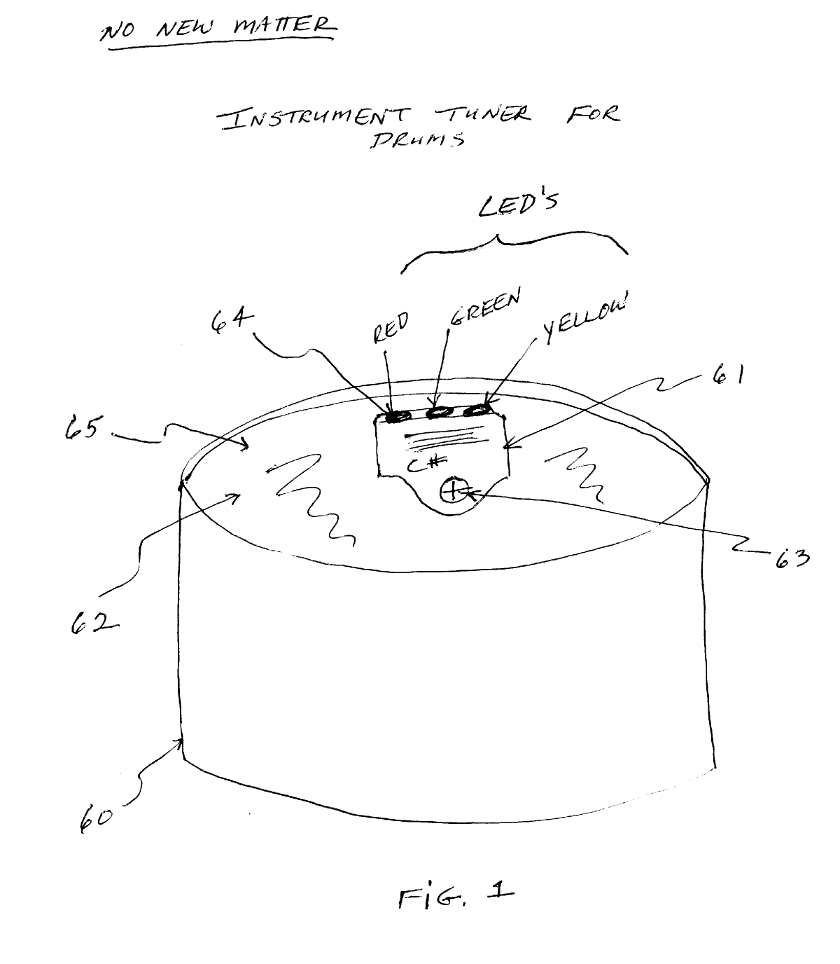

Referring to FIG. 1 (as only one example of the invention disclosed) there is shown a drum/or individual drum shell 60 having a hollow body 62 with a top surface/or drum head 65. The fundamental shell note in this example is C#. and this could be marked or printed on the inside of the drum shell, as just one example. The corresponding single-note drum tuner is also pre-set or predetermined to be C#. The single-note drum tuner 61 has a hole for a screw to go through 63 into the side of the drum and finally into the drum mounting hardware on the outside of the drum shell. The top of the single-note drum tuner 64 can have a combination of colored LED display lights 66 (a yellow LED light flashes when the tone has a frequency above that of the note, a red LED light flashes when the tone has a frequency below that of the note and a green LED light flashes when the tone has the same frequency as the note.) Again, multi-colored LED lights could be used to reduce the number of LED lights needed. Both the red and yellow LED lights could flash green at the same time when the tone of the drum has the same frequency as the pre-set or predetermined note of the drum tuner, as just one example. The single-note drum tuner could be battery operated or solar powered. The drum tuner could be very small in size and low cost to manufacture; one installed in each drum and easily visible through the top/or bottom drum head(s).

While reference has been made only to a single drum, in fact, it is obvious that the “single-note” drum tuner would also work for other musical instruments such as entire drum sets, and many different types of drums and drum combinations. The sensing means will always be internal to the drum, but the tuner, measurement means, and/or display means could be external to the drum. In addition, a wireless device or system could be an integral part of this invention where the sensing means is internal to the drum, that then sends a wireless signal to the external tuner, measurement means and/or display that could all be external to the drum. In addition, the instrument tuner for drums may be for a single-note only, or multiple notes for an entire drum set.

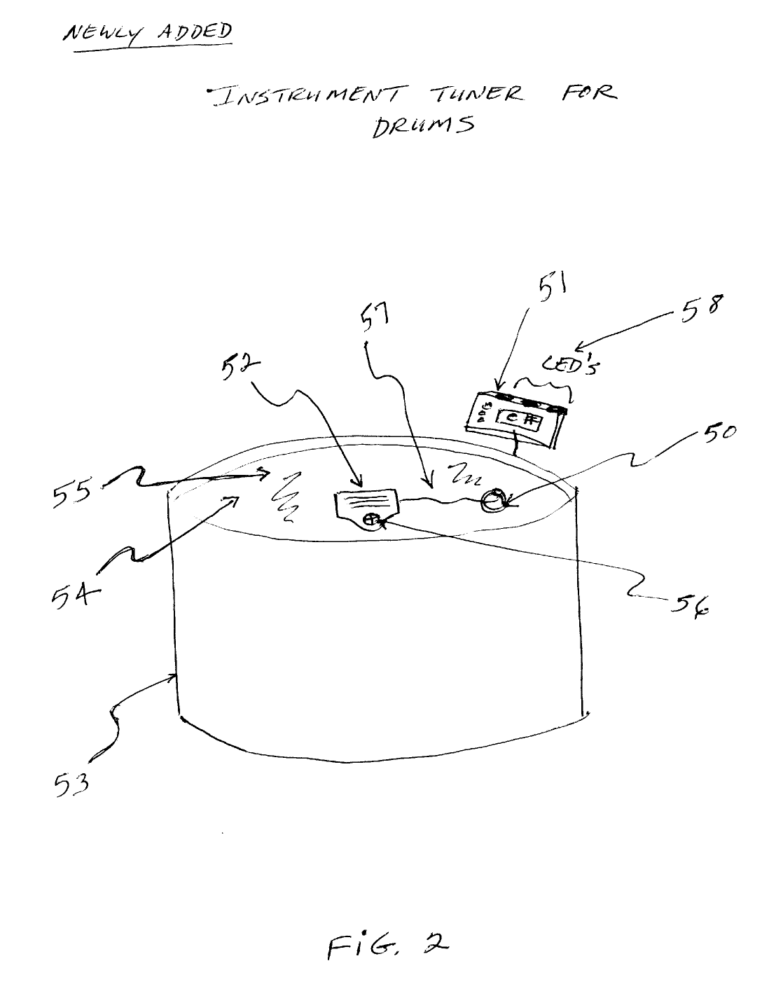

Referring to FIG. 2 (as only one more example of the invention disclosed) there is shown a drum/or individual drum shell 53 having a hollow body 54 with a top surface/or drum head 55. The microphone (or sensing means) 52 has a hole for a screw to go through 56 into the side of the drum and finally into the drum mounting hardware on the outside of the drum shell. The internally mounted microphone (52) (one e.g. of a sensing means) is connected to the drum tuner 51 and display 58 (that are both external to the drum) by way of a hard wire (57) going through the vent hole of the drum (50), and then to the external drum tuner (51) and display. The display may have an LCD display, colored LED lights, one of these . . . or both. The drum tuner and display could be mounted externally on the drum or away from the drum in another location where it is easy for the user/or drummer to see.

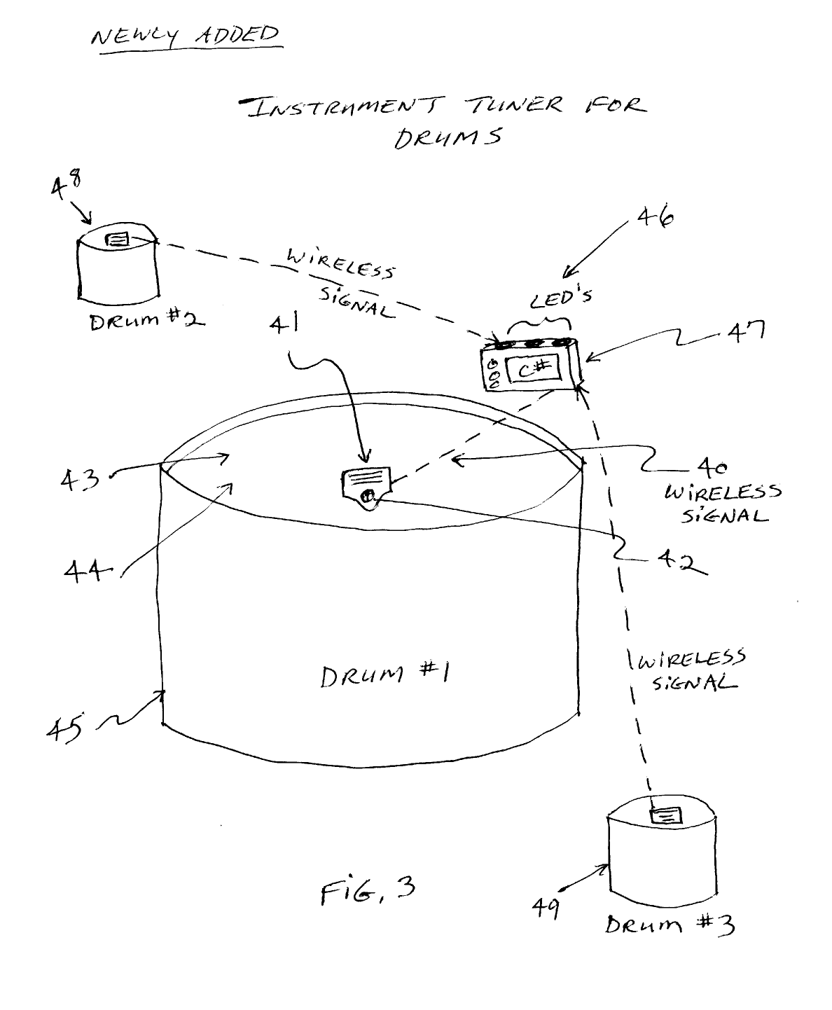

Referring to FIG. 3 (as only one more example of the invention disclosed) there is shown a drum/or individual drum shell 45 having a hollow body 44 with a top surface/or drum head 43. The microphone (or sensing means) 41 has a hole for a screw to go through 42 into the side of the drum and finally into the drum mounting hardware on the outside of the drum shell. The internally mounted microphone (41) (one e.g. of a sensing means) sends a wireless signal to the drum tuner 47 and display 46 (that are both external to the drum) by way of a wireless signal or wireless method (40). The display may have an LCD display, colored LED lights. one of these . . . or both. The drum tuner and display could be mounted externally on the drum or away from the drum in another location where it is easy for the user/or drummer to see. A single drum can be used with this method, or several drums (45. 48 and 49) could send additional signals all to a single drum tuner (47) and display that are external to the drum. Every drum in a drum set could have an internal microphone (as one e.g. of a sensing means) all sending wireless signals to an external drum tuner and display (47) where the combined fundamental resonance and pitch from inside each drum is measured, selected, and displayed. A button(s) or switch(s) on the drum tuner (47) could be changed to show the musical note of each drum, taken from inside the drum using a microphone and wireless signal, as only one example, that measures the combined fundamental resonance and pitch from inside each drum.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

What is claimed is:

1. An instrument tuner for drums that has a sensing means for sensing the combined fundamental resonance and pitch of a drum.

2. An instrument tuner for drums that has a sensing means for sensing the combined fundamental resonance and pitch of a drum of claim 1, wherein the instrument tuner has a measurement means for measuring a frequency of said combined fundamental resonance and pitch.

3. An instrument tuner for drums wherein the instrument tuner has a measurement means for measuring a frequency of said combined fundamental resonance and pitch of claim 2, wherein the measurement means could be either internal or external to the drum.

4. An instrument tuner for drums of claim 3, wherein the measurement means could be through the use of a wireless device or system, where sensors or microphones could be either internal or external to the drum(s).

5. An instrument tuner for drums that senses the combined fundamental resonance and pitch of a drum of claim 1, wherein the instrument tuner senses the combined fundamental resonance and pitch of the drum and then measures and compares that to a single pre-determined note of the drum tuner.

6. An instrument tuner for drums of claim 5, wherein the measurement and comparison means could be through the use of a wireless device or system.

7. An instrument tuner for drums that senses the combined fundamental resonance and pitch of a drum of claim 1, wherein the instrument tuner senses the combined fundamental resonance and pitch of the drum and then measures, compares, and displays the corresponding musical note through a selection means.

8. An instrument tuner for drums that has a sensing means for sensing the combined fundamental resonance and pitch of a drum of claim 1, wherein said sensing means comprises a microphone or sensor.

9. An instrument tuner for drums of claim 8. wherein said sensing means comprises a microphone or sensor that is separate from the tuner that is external to the drum.

10. An instrument tuner for drums of claim 9, wherein said sensing means comprises a microphone or sensor that is separate from the tuner wherein the tuner is external to the drum using a wireless device or system.

11. An instrument tuner for drums that has a sensing means for sensing the combined fundamental resonance and pitch of a drum of claim 1, wherein said sensing means detects frequency of the note through vibration and not microphone.

12. An instrument tuner for drums of claim 11, wherein said sensing means is separate from the tuner that is external to the drum.

13. An instrument tuner for drums of claim 12, wherein said sensing means is separate from the tuner wherein the tuner is external to the drum using a wireless device or system.

14. A method and instrument tuner for drums that measures the combined fundamental resonance and pitch of a drum, which comprises: (a) a sensing means for sensing a musical note of a drum from either inside or outside the drum; and (b) a measurement means for measuring a frequency of said musical drum note; and (c) a selection means for selecting a predetermined lower frequency of the drum note determined through sensing and measuring, a predetermined central frequency of the drum note determined. and a predetermined upper frequency of the drum note determined, said selection means comprising a stored table of frequencies, the lower, central and upper frequencies selected from said stored table as a function of said musical note sensed by said sensing means; and (d) an indicator means for indicating: an off or inactive indication if said frequency of musical drum note sensed and measured is less than said predetermined lower frequency; and an off or inactive indication if said frequency of said musical drum note is greater than said predetermined upper frequency; and a SHARP indication if said frequency of said musical drum note is less than or equal to said predetermined upper frequency and greater than or equal to said predetermined central frequency; and a FLAT indication if said frequency of said musical drum note is greater than or equal to said predetermined lower frequency and less than or equal to said predetermined central frequency.

15. An instrument tuner for drums that measures the combined fundamental resonance and pitch of a drum of claim 1 wherein said sensing means comprises a connection to an electrical signal representative of said musical drum note.

16. An instrument tuner for drums that measures the combined fundamental resonance and pitch of a drum of claim 1 wherein said sensing means comprises a microphone or sensor integral to said tuner.

17. An instrument tuner for drums that measures the combined fundamental resonance and pitch of a drum of claim 1 wherein said sensing means internal to the drum comprises a microphone or sensor that is separate from a display that is outside the drum.

18. An instrument tuner for drums that measures the combined fundamental resonance and pitch of a drum of claim 1 wherein the display only shows or lights-up when the frequency of the drum pitch measured is within the range of the pre-determined single-note of the tuner.

19. An instrument tuner for drums that measures the combined fundamental resonance and pitch of a drum of claim 1 wherein said indicator and display means comprises an illuminatable element of at least one color.

20. An instrument tuner for drums that measures the combined fundamental resonance and pitch of a drum of claim 1 further including a control means for controlling the power state of said tuner.

21. An instrument tuner for drums that measures the combined fundamental resonance and pitch of a drum of claim 1 further including a control means for controlling the power state of said tuner, said control means comprising a mechanical switch.

22. An instrument tuner for drums that measures the combined fundamental resonance and pitch of a drum of claim 1 wherein said selection means selects said predetermined central frequency as one of two frequencies: a first frequency if said musical drum note is sharp; and a second frequency if said musical drum note is flat, whereby said selection provides compensation for overshoot in tuning on the part drummer.

23. An instrument tuner for drums that measures the combined fundamental resonance and pitch of a drum of claim 1 wherein said sensing means is comprised of a connection between said measurement means and an electrical signal representative of said musical drum note external to said musical instrument drum tuner.

24. An instrument tuner for drums that measures the combined fundamental resonance and pitch of a drum of claim 1 wherein an indication of a predetermined duration in the case said frequency of said musical drum note is within a predetermined proximity to a predetermined note whereby said indication informs the user that the drum pitch is near said predetermined drum note to give the user a point of reference while tuning the drum.
